(19) United States
(12) Patent Application Publication
(10) Pub. No.: US 2022/0051273 A1
(43) Pub. Date: Feb. 17, 2022

(54) Telecommunications Data Used For Lookalike Analysis

(71) Applicant: Eureka Analytics Pte Ltd, Singapore (SG)

(72) Inventors: Ying Li, Singapore (SG); Aloysius Lim, Singapore (SG)

(73) Assignee: Eureka Analytics Pte Ltd, Singapore (SG)

(21) Appl. No.: 17/274,470

(22) PCT Filed: Sep. 10, 2018
(86) PCT No.: PCT/SG2018/050459

§ 371 Date: Mar. 9, 2021

(51) Int. Cl. G06Q 30/02; H04W 4/23; H04L 29/08; H04W 4/029

(52) U.S. Cl. CPC G06Q 30/0205; H04W 4/23; G06Q 30/0246; H04W 4/029; H04L 67/22

(57) ABSTRACT

A system may generate abstracted graphs from a social relationship graph in response to a query. A query may identify a person for which permission has been obtains to collect their data. The abstracted graphs may include summary statistics for various relationships of the person. The relationships may include other persons, places, things, concepts, brands, or other object that may be present in a social relationship graph, and the relationships may be presented in an abstracted or summarized form. The abstracted form may preserve data that may be useful for the requestor, yet may prevent the requestor from receiving some raw data. When two or more people have given consent, the data relating to the consenting persons may be presented in a non-abstracted manner, while other data may be presented in an abstracted manner.

### CROSS REFERENCE TO RELATED APPLICATIONS

This application claims priority to and benefit of PCT Application PCT/SG2018/050459 “Telecommunications Data Used for Lookalike Analysis” filed on 10 Sep. 2018 by Eureka Analytics Pte. Ltd., the entire contents of which are hereby incorporated by reference for all they disclose and teach.

### BACKGROUND

Telecommunications network providers often log interactions between their subscribers and the network. In the case of mobile telephony providers, base stations may retain logs of communications between the base station and any mobile devices connected to the base station, as well as Call Detail Records and many other sources of data.

### SUMMARY

Lookalike subscribers may be derived from telecommunications data, such as call and messaging detail records, cell tower interaction logs, and financial interaction data. From these datasets, graphs of subscriber behaviors and connections may be generated. A set of seed users may include telephone numbers of target subscribers, from which lookalike subscribers may be found. The list of seed users may be curated over time, based on feedback of conversions or other similar data. The curation may include adding high performing users and removing low performing users from the list of seed users.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a telecommunications network and creating pseudo-social graphs from the data.

FIG. 2 is a diagram illustration of an embodiment showing a network environment for generating graphs from telecommunications data.

FIG. 3 is a flowchart illustration of an embodiment showing a method for generating graphs.

FIG. 4 is a diagram illustration of an embodiment showing various data sources that may be available from a telecommunications network.

FIG. 5 is a flowchart illustration of an embodiment showing a method for processing a seed user list to find similar subscribers.

FIG. 6 is a flowchart illustration of an embodiment showing a method for processing a campaign.

FIG. 7 is a flowchart illustration of an embodiment showing a method for determining creditworthiness of a subscriber.

### DETAILED DESCRIPTION

Subscriber Analysis from Telecommunications Data

Telecommunications networks may capture usage data for various uses. In many cases, usage data may be used for billing purposes, such as for data plans where users pay for certain data usage per month, or for talk plans where a user may pay for a number of minutes used with voice or the number of text or SMS messages sent or received. In addition, usage data may be used for network load balancing, capacity monitoring, network routing, and other uses.

These data sources may include very interesting data components about a person's behaviors, personalities, likes and dislikes, and other characteristics. Telecommunications data may include, for example, a person's movements from one location to another, as well as their social connections to other subscribers and the apps, websites, or other usages of the subscriber's phone or other device. A telecommunications network may also have meaningful financial data, at least with respect to how a user pays their bills, whether they subscribe to prepaid plans or pay-as-you-go, how frequently they top up their accounts, the method of payment, and other factors.

In many cases, some telecommunications data may be regulated under various privacy laws, and different types of data may have different degrees of privacy. Many countries prohibit wiretapping without a court order, so the content of telephone conversations between subscribers may be highly guarded. However, the Call Detail Records are often considered less private. Similarly, the logs of connections between a mobile device and a cell tower may be even less private, since such information may be gleaned by merely monitoring over the air communications.

Telecommunications usage data may be very rich but also may contain a large amount of ambiguity. For example, a cell tower log may contain a record for a subscriber's device being within the vicinity of a tower near a hospital. Such a record may be captured because the subscriber visited the hospital, but could also be because the subscriber visited a business or a park nearby the hospital. Further, even if the subscriber visited the hospital, the subscriber may be undergoing treatment, visiting a friend or relative, or may work at the hospital. Each of these possible reasons for visiting the area may indicate different characteristics about the subscriber.

In the example of the hospital visit, an advertiser may wish to target specific types of people for a product or service. An advertiser for medical devices may wish to target doctors who work at the hospital, while an advertiser for an ice cream store may wish to target young families who visit to the nearby park. Given the ambiguity of the cell tower connection data, precise targeting may not be possible using the cell tower connection data alone.

Telecommunications data, as in the hospital example, may not have “ground truth” available to confirm specific characteristics about a subscriber. For example, a telecommunications operator may not have access to a subscriber's occupation or for their purpose of visiting the vicinity of the hospital. Because of the limited amount of data available to the telecommunications operator, the desired specificity of the advertiser may not be met.

In some cases, telecommunications data may be supplemented by other data sources. For example, a listing of property owners may be cross referenced with information that a telecommunications company may possess, such as a subscriber's name and address. However, such data may be expensive and, as in the case of property owners, may not cover the entire corpus of subscribers.

Telecommunications data may be very noisy and is often incomplete. For example, location information may return the approximate location of a subscriber based on the Global Positioning System coordinates of the base station or tower. If the tower becomes overloaded or near capacity, the user's device may be switched to communicate with a distant tower, even though the user has not changed location. A connection log may show the user's movements, even when none have occurred. Further, many networks may be comprised of equipment from several different manufacturers. Each manufacturer may provide different data points in their log entries, with some manufacturers providing much more data than another manufacturer.

Lookalike Engine for Telecommunications Data

A lookalike engine for telecommunications data may determine similarities between subscribers by comparing the observed subscriber behavior within available telecommunications data. The telecommunications data may be organized into one or more mathematical graphs that may capture relationships observed in the data, and may compare subscribers based on their similarities within the graphs.

The mathematical graphs may include graphs depicting physical interactions, online interactions, social interactions, and other observations. A graph may have a node depicting a common element, such as a physical location, and an edge defining the relationship of a subscriber to that location. In the online world, a node may be a website, application, or other online entity where a subscriber interacts, and in a social graph, a node may be a person, business, brand, company, or other entity with which the subscriber may interact.

The graphs may be generated by analyzing historical observations of a subscriber as the subscriber interacts with a telecommunications network. The observations may include records of the cell towers to which a subscriber connected, the websites visited, the other subscribers with whom the subscriber interacted, along with other data.

The graphs may include a time domain component. A time domain component may be a variable or factor that reflects the time an event happens, and may include the event's time of day, day of week, as well as its frequency, mean and deviation from mean, and other factors. The time domain component may be another factor for identifying similarities between users.

Uses for Lookalike Engine

A lookalike engine may be used for identifying subscribers that may be similar to a set of seed users. In an advertising scenario, an advertiser may supply phone numbers for current customers as seed users. The seed users may be a specific set of current customers, such as those with good track records for purchases and for prompt payment.

The lookalike engine may find targeted subscribers that are similar to the seed users by analyzing the graphs of telecommunications data. The targeted subscribers may have similar characteristics to the seed users.

The lookalike engine may use graphs that may or may not have semantic inferences in the data. Semantic inferences may include items such as gender, family income, occupation, and other information. Such inferences may be useful for identifying demographic-related targets.

In many cases, a set of graphs may be constructed without semantic information. Such graphs may be mathematically derived, where the mathematically derived factors may not correlate with any specific demographic factors. Such graphs may have better matching performance than analyses that attempt to assign demographic or other semantic information to subscribers, then use the semantic factors to find candidate subscribers.

Feedback Loop and Managing the Seed User List

The seed user list may be refined over time by using a feedback loop to add new members to the seed list and to remove members that may not represent the type of subscribers being sought. A metric for evaluating performance of a seed user list may be some form of conversion, which may be a response to an advertising, a measurable change in behavior, or some other metric.

A feedback metric may be a measurable metric that may indicate whether a message was successful in eliciting a change. In an advertising scenario, a message may be sent to a subscriber, who may respond by clicking a link, viewing a landing page, and making a purchase. In such a scenario, the user's click, viewing, and purchase may be measured and, based on such feedback, may cause adjustments to be made to the seed user list.

The seed user list may be refined by adding high performing subscribers and removing low performing subscribers. High performing subscribers may be those subscribers having a high conversion rate. Low performing subscribers may be those with a poor conversion rate. The updated list may be used to generate additional lookalike subscribers for future campaigns or to refine a campaign already in progress.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

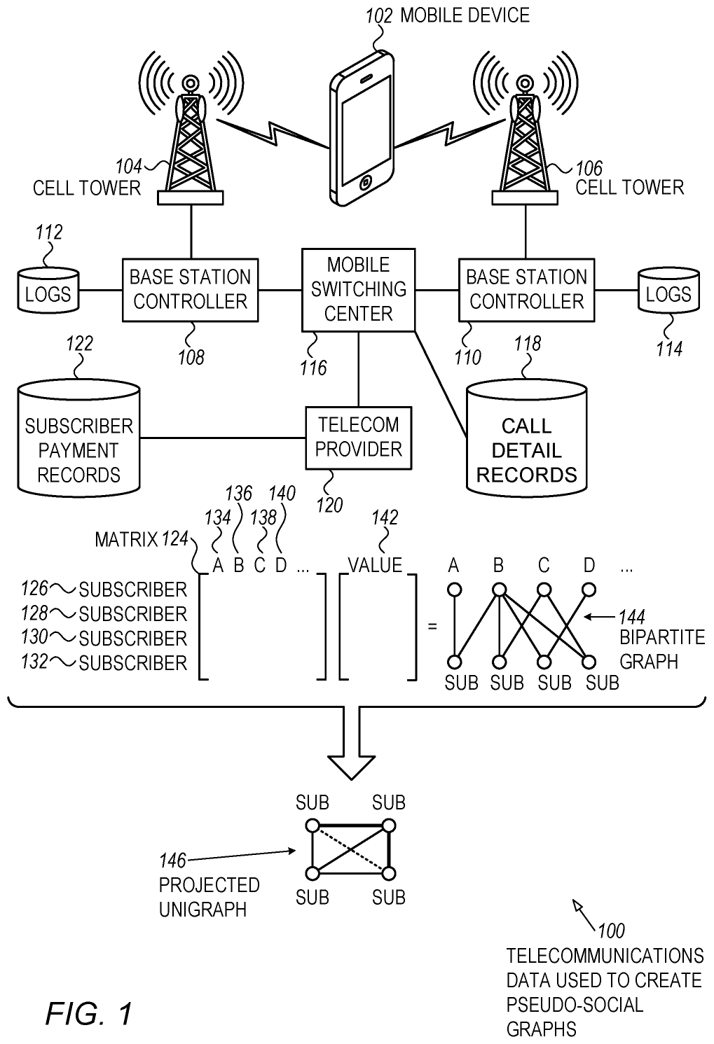

FIG. 1 is a diagram illustration of an embodiment 100 showing a system for analyzing telecommunications data to create pseudo-social graphs. The pseudo-social graphs may represent the similarities between subscribers using many different data points available from telecommunications service providers. The similarities may have many different use cases, such as advertising campaigns, credit worthiness evaluations, and other uses.

Telecommunications data may represent a very large and very deep data set which may be analyzed to identify lookalike subscribers with closely matching behaviors. In many cases, the raw telecommunications data may be rich enough and detailed enough to identify similar or lookalike subscribers without having to identify semantic classifications, such as gender, age, occupation, and the like. Such classifications may be difficult because a telecommunications provider may not have the ground truth to validate such classifications. By using merely the data available to a telecommunications provider, powerful and meaningful similarities may be found between subscribers.

One of the benefits and one of the challenges of using telecommunications provider data is that the amount of data may be extraordinarily large. The large amount of data may mean that very detailed and rich subscriber behaviors may be captured, however, the large amount of data may be costly to process and analyze. Large volumes of telecommunications data may be condensed into pseudo-social graphs that may be readily searched for similar subscribers. The graphs may be updated periodically, and some systems may update some graphs in real time.

A telecommunications network, such as a cellular telephone network, may connect to a mobile device 102 through various cell towers 104 and 106. Each cell tower 104 and 106 may be connected to a base station controller 108 and 110, respectively, and each base station controller 108 and 110 may generate various logs 112 and 114, respectively.

The base station logs 112 and 114 may contain records of communications between the mobile device 102 and the respective base station. The logs may include not only audio, text, and data communications, but also the periodic heartbeat communications when a device may be in range of a cell tower but may not be otherwise transmitting. Such heartbeat communications, when assembled together for a specific device, may show where the device traveled, even when the user may not be using the mobile device 102. In many cases, a mobile device 102 may ping nearby base stations every several seconds or so, creating an extremely large set of data.

The logs 112 and 114 may reveal where and when a device may have moved. When examining subscribers for similarities, a subscriber's mobility may reflect various characteristics about the subscriber. For example, subscribers may be classified by their radius of gyration, which may reflect the furthest distance that they may travel during a week. Some subscribers may have a very tight radius of gyration, while others may have much larger radius of gyration.

Additional classification may be made by analyzing changes to a subscriber's radius of gyration. For example, many people may visit the same basic locations on a repeated basis, such as to school, gym, work, grocery store, and the like. When a person makes trips outside of their normal set of locations, such a trip may indicate an anomalous data point, which may be a point of similarity with another subscriber.

In some cases, changes to a subscriber's radius of gyration may indicate life change events. For example, a change in a subscriber's job, school, or home may be reflected in changes to the center of a radius of gyration. Such events may indicate a subscriber's potential willingness to make other changes to their life, which may be as simple as changing brands of toothpaste to planning an exotic vacation.

A mobile switching center 116 may manage the calls, messages, and other communications between the mobile device 102 and other mobile devices, the internet, Public Switched Telephone Network, and other connections. The mobile switching center 116 may create various call detail records 118 and other logs of communications.

The call detail records 118 may include records of the communications between subscribers, including the origin and destination identifiers, the length of communications, data consumed, and other metadata about the communication. In some cases, the records created by a mobile switching center 116 may include app usage on a cell phone or tablet computer, any websites visited, and other metadata about the usage of the mobile device 102.

From the call detail records 118, information about a subscriber's communication habits may be inferred. For example, a subscriber's social connections with other subscribers may be inferred, along with their affinity with different websites, their app usage, and other online behavior. Such behavior profiles may give meaningful differentiation between users, such that similarly behaving users online and socially may respond similarly to advertisement campaigns, have similar creditworthiness, and share other similar properties.

A telecom provider 120 may also have subscriber payment records 122. The subscriber payment records 122 may include the subscription plan, history of payments, on time and late performance, method of payments, usage history, payment default history, and other factors. Such data may be used to match similar subscribers, but also may be used to predict a subscriber's creditworthiness by determining the creditworthiness of similar subscribers.

A subscriber data matrix 124 may contain data records for various subscribers 126, 128, 130, and 132. The parameters 134, 136, 138, and 140 may be various characteristics or parameters that may be derived from one of the many data sources, such as base stations logs 112 and 114, call detail records 118, subscriber payment records 122, and other data sources. A values vector 142 may be a weighting applied to the matrix 124, which may yield a bipartite graph 144. The bipartite graph 144 may be further consolidated into a projected unigraph 146. The projected unigraph 146 may be considered a pseudo-social graph, which may link subscribers together based on their affinity to the parameters used to generate a graph.

The parameters 134, 136, 138, and 140 may be any value or derived value taken from the various data sources. In some cases, the raw data value may be used. For example, the cell tower location may be used as a parameter. In other cases, the parameters may be a summarized or processed parameter, such as the radius of gyration.

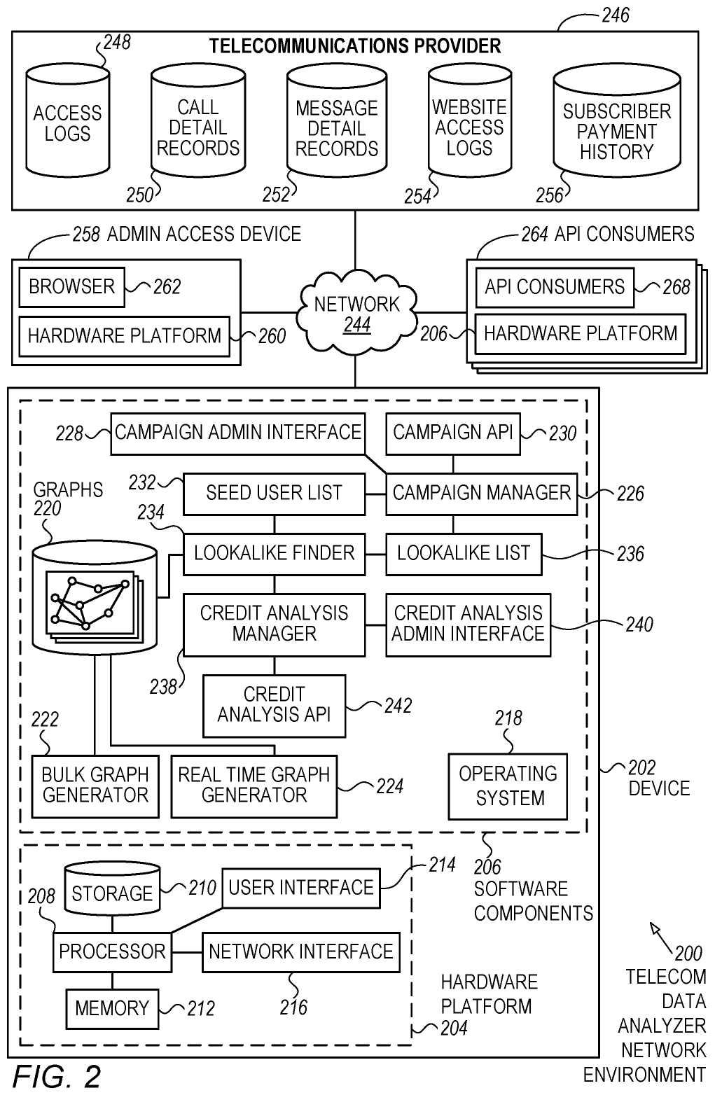

FIG. 2 is a diagram of an embodiment 200 showing components that may create graphs derived at least in part from telecommunications data and from which similarity analyses may be performed. The similarity analyses may be used for advertising campaigns, creditworthiness, and other analyses.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A set of graphs 220 may be derived from telecommunications data, such as cell tower logs, call detail records, and other data sources. The graphs 220 may be consolidated versions of the telecommunications data, which may be readily analyzed for similarities in various contexts.

A bulk graph generator 222 may be a mechanism by which large amounts of historical data may be processed into various graphs. A real time graph generator 224 may be a mechanism which may make periodic updates to the graphs. Some systems may have certain graphs where historical data may be sufficient for similarity scores. Other systems may have certain graphs where periodic updates may be useful. For example, graphs that may be based on changes to radius of gyration may be updated regularly to help identify those subscribers whose radius of gyration has changed recently.

A lookalike finder 234 may be a process or mechanism where a set of similar subscribers may be found for a given subscriber. In some analyses, a set of subscribers may be presented as input, where the lookalike finder 234 may return a set of similar subscribers. In other analyses, a single subscriber may be presented, and a set of similar subscribers may be returned.

A campaign manager 226 may be a process or application that may manage an advertising campaign. The campaign manager 226 may have campaign administrative interface 228 and a campaign application programming interface 230. The campaign administrative interface 228 may be a user interface through which a campaign may be configured, executed, and monitored. In a typical design, the campaign administrative interface 228 may be a website or HTML interface.

The campaign application programming interface 230 may be a service that may respond to computer-generated requests for campaign information. In some cases, the campaign application programming interface 230 may allow a remote application to configure, execute, and manage a campaign.

A campaign may begin with a seed user list 232, which may include telephone numbers of a group of users for which matches are desired. In an advertising campaign, a brand may provide a list of telephone numbers for ideal customers. Those customers may be used as a first seed user list 232. The seed user list 232 may be consumed by the lookalike finder 234 to generate a lookalike list 236. The lookalike list 236 may include subscribers that have mathematical similarities to the members of the seed user list.

In many campaigns, a campaign manager 226 may update the seed user list 232 by determining how each seed user preformed, and adding or removing seed users to improve the performance of a subsequent campaign.

A credit analysis manager 238 may have a credit analysis administrative interface 240 and a credit analysis application programming interface 242. The credit analysis administrative interface 240 may be a user interface through which credit analysis analyses may be configured, managed, and monitored. The credit analysis application programming interface 242 may be a computer-accessible interface or service through which the various credit analysis functions may be accessed.

The device 202 may communicate with other devices over a network 244, including a telecommunications provider 246. A telecommunications provider 246 may provide access to various databases, such as cell tower access logs 248, call detail records 250, message detail records 252, website access logs 254, subscriber payment history 256, and other data sources, such as app usage logs.

An administrative access device 258 may have a hardware platform 260 on which a browser 262 may operate. The administrative access device 258 may be a device through which the various administrative interfaces may be accessed.

Application programming interface consumers 264 may be devices having a hardware platform 266 on which various API consumer applications 268 may operate. The application programming interface consumers 264 may be applications that may automatically access the various application programming interfaces of the device 202.

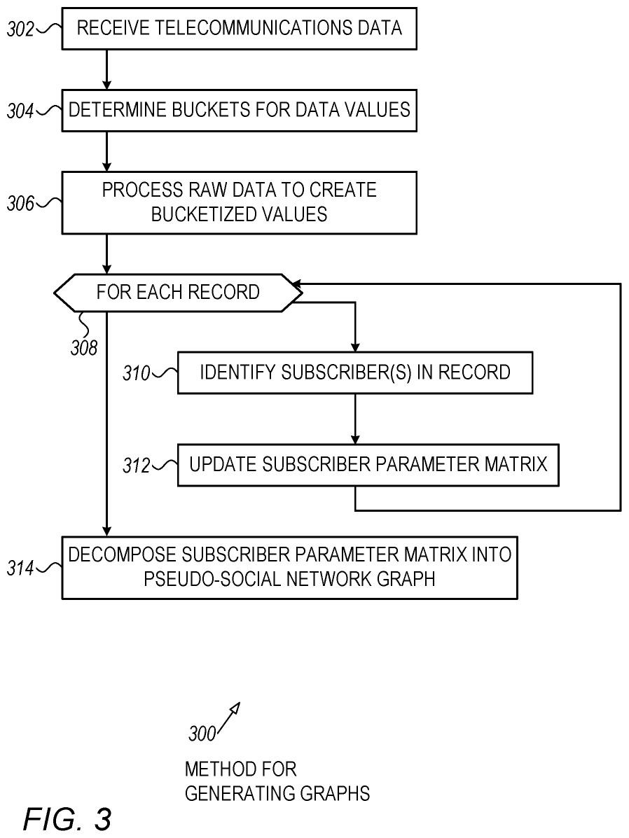

FIG. 3 is a flowchart illustration of an embodiment 300 showing a method of generating graphs. Embodiment 300 is a simplified example of a sequence for processing telecommunications data and creating a searchable graph.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 300 is merely one example of how a system may process telecommunications data into pseudo-social graphs, such as may be illustrated in embodiment 100.

The telecommunications data may be received in block 302. For the data set, various buckets of data values may be determined in block 304.

The buckets of data values may represent categories for a specific variable. For example, a graph may be constructed where each category may be a time of day when a user may move the farthest. The category may be allocated into different time buckets, which may be every 2 hours. Such a category may have 12 buckets, and a subscriber's motion may be derived from cell tower data logs, then allocated into one of the 12 buckets. This is merely one example of a data variable for which a graph may be created.

The raw telecommunications data may be processed in block 306 to create the bucketized values. In the example above, cell tower data logs may be identified to associate the subscriber's movements, then the subscriber's movements may be analyzed to find the time of day of farthest movements. For each data record in block 308, the subscriber or subscribers associated with the record may be identified in block 310, and the subscriber parameter matrix may be updated in block 312.

After updating the subscriber parameter matrix in block 312, the matrix may be decomposed into a pseudo-social network graph in block 314.

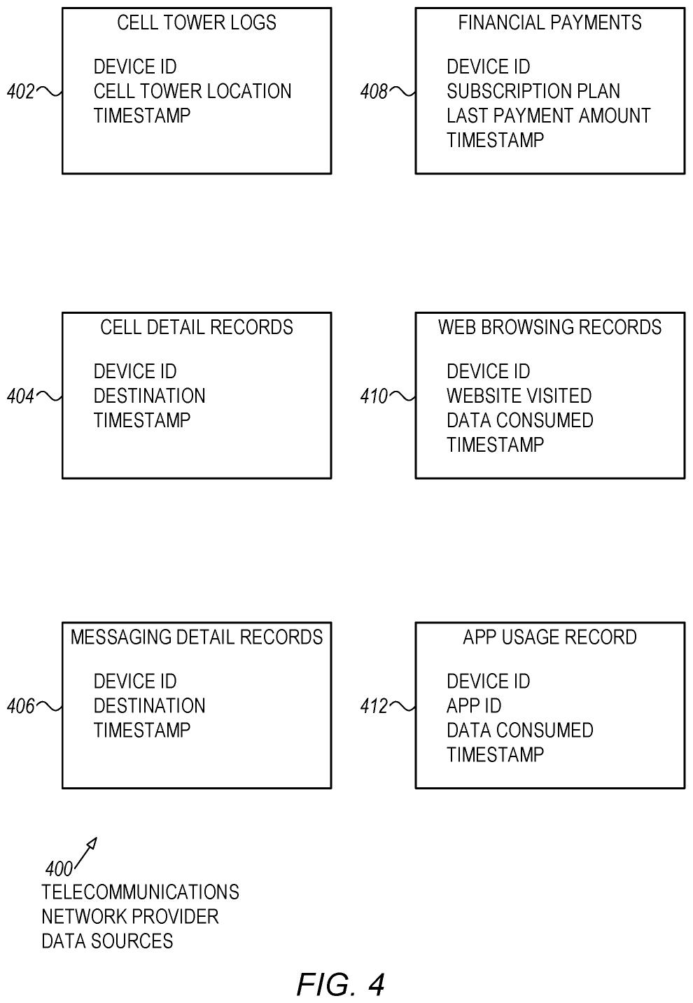

FIG. 4 is a diagram illustration of an embodiment 400 showing some of the data sources that may be available within a telecommunications network.

Cell tower logs 402 may contain records of communications between a mobile device and a cell tower. While this set of logs may contain information about data and voice communications, much of the data may relate to the connections and signaling between the towers and the mobile device. Such systems often have a heartbeat communication that may sense the signal strength of a device from which location may be inferred, and by consolidating several cell tower data logs, a device's movements through the network may be captured.

Cell tower data logs may be valuable to infer a subscriber's movements, however, cell tower data logs may contain extremely large amounts of data.

Call detail records 404 and message detail records 406 may contain records of calls or messages between a subscriber and another device. In some cases, the call or message may be passed between two subscribers within the same telecommunications network, while in other cases, a call or message may originate or terminate outside the network.

Call detail records 404 and message detail records 406 may contain metadata about communications, and often do not contain the content of communications between subscribers. Some jurisdictions may consider recording or analysis of the content of communications to be wiretapping, which may be illegal without proper approval. Even when the detail records contain metadata only, measurements may be made regarding a subscriber's communication habits, such as the frequency and length of calls, the social connections between various subscribers, the communications between a subscriber and various businesses or brands, and many other factors.

Financial payment records 408 may contain information about payments made by a subscriber to the telecommunications provider. The payment records may also include payments made by a subscriber to third parties when the payment may be made through the telecommunications provider. The payment records may include any details about a subscriber's subscription plan, the subscriber's payment frequency, history, method of payment, and many other variables. The payment records may be used to identify subscribers who may have good or bad payment histories. Such histories may be used as one similarity mechanism, but also may be used to estimate one subscriber's default rate or creditworthiness.

Web browsing records 410 and app usage records 412 may include records of data consumption by a device. These records may indicate which website a user may have visited, as defined by the website address, as well as the amount of data consumed, the length of time on the site, and other behavioral metadata. The app usage records may be similar but may include specific apps used on the device.

Graphs may be created through relatively raw forms of these data items. For example, a graph may be constructed by using the cell tower connection log to monitor whether a subscriber passed by a specific location. Such a graph may be constructed from a binary values of 0 or 1 for whether the subscriber's device was connected to the tower. Even with such coarseness, meaningful analyses of subscriber similarities may be captured.

In some cases, graphs may be constructed through more sophisticated analyses of the raw data. For example, a radius of gyration may be determined for each subscriber. A radius of gyration may represent the furthest distance the subscriber may normally travel in a given period. Such a data point may be the result of combining cell tower logs from across a provider's network, then developing a radius value. Such a graph may represent a different set of similarities between subscribers, which may have value in different contexts.

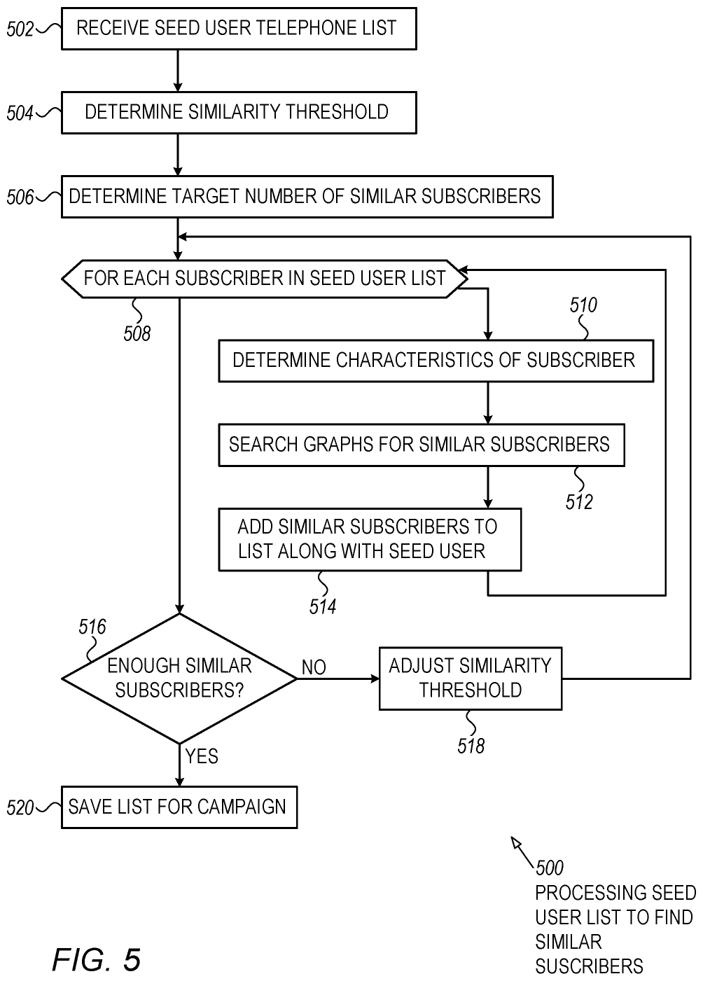

FIG. 5 is a flowchart illustration of an embodiment 500 showing a method of processing seed users to find similar subscribers.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 500 may illustrate a method by which seed users may be processed to find similar subscribers within a telecommunications network. The seed users may represent the characteristics of desired subscribers. In an advertising context, a set of seed users may be existing customers of an advertising client. In some cases, a set of seed users may represent a set of “ideal” customers, such as customers who yield the highest returns or who made specific purchases in the past.

The similarity analysis of a seed user list may use a relatively large number of graphs that may represent many different behaviors of subscribers. The graphs may be purely mathematical constructs that may or may not represent demographic or other categories. Such a system may uncover similarities that may not have been recognized using demographic-based graphs or other categorized data.

A seed user telephone list may be received in block 502. The seed user list may consist purely of telephone numbers, which may be correlated to devices by a telecommunications network.

A similarity threshold may be determined in block 504. The similarity threshold may be a correlation matching factor that may determine when a match exists or not. The similarity threshold may be adjusted in subsequent steps to increase the number of matching subscribers. A target number of similar subscribers may be determined in block 506.

For each subscriber in the seed user list in block 508, the characteristics of the subscriber may be determined in block 510, and, using those characteristics, the graphs may be searched in block 512 to find similar subscribers. The similar subscribers may be added to a list in block 514.

The subscriber's characteristics may be those factors that may be references in the graphs. For example, a seed user's radius of gyration may be a characteristic. The seed user may be located within the telecommunications network data and a radius of gyration may be calculated for the seed user. That radius of gyration may then be used to search for similar users. In a typical analyses, several different characteristics may be identified and searched for each seed user.

If the similarity analysis does not produce the target number of subscribers in block 516, the similarity threshold may be adjusted in block 518 and the process may return to block 508 to re-process the seed user list. If the target number of subscribers has been achieved in block 516, the list may be saved for a campaign in block 518.

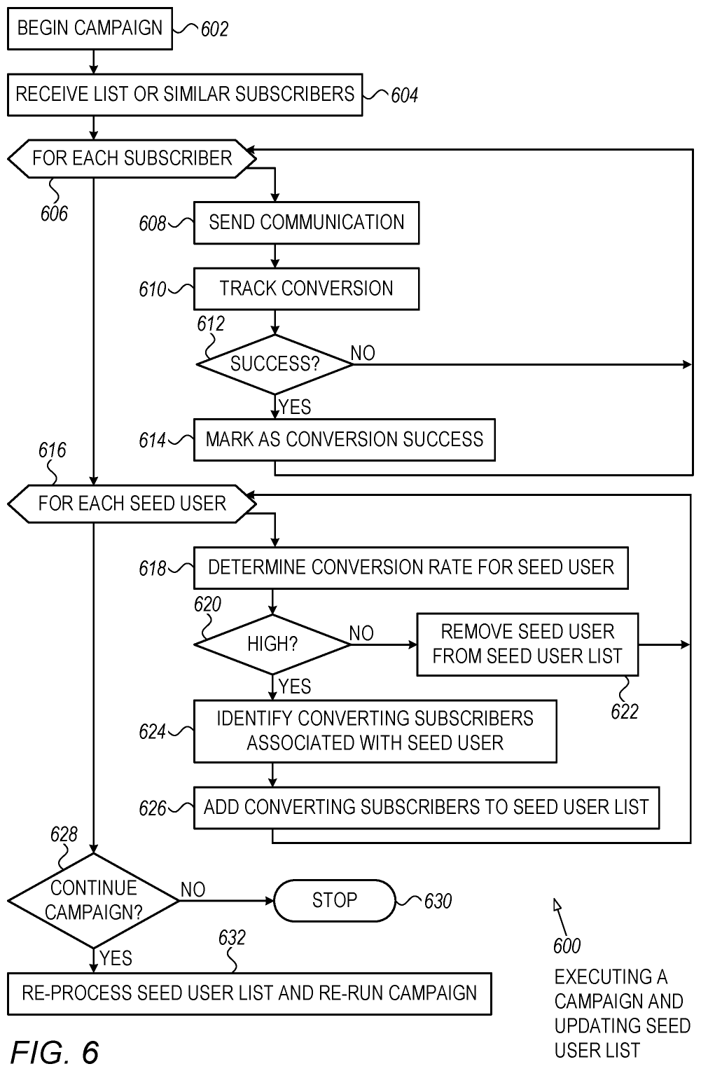

FIG. 6 is a flowchart illustration of an embodiment 600 showing a method of executing an advertising campaign using similar subscribers, then updating a seed user list.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 600 may represent a method for exercising a campaign, then updating a seed user list. The process of refining a seed user list may allow a campaign to perform at a higher level with each iteration. A feedback mechanism may be a conversion of some sort. A conversion may be a positive response to an advertisement, such as clicking on an initial advertisement, making a purchase, or some other measurable event. The conversion may be an indicator of success for which additional seed users may be added or non-performing seed users may be removed from the seed user list.

A campaign may begin in block 602. A list of similar subscribers may be received in block 604. The list may be a list such as described in embodiment 500.

For each subscriber in block 606, a communication may be sent to the similar subscriber in block 608 and a conversion may be tracked in block 610. If the conversion was not a success in block 612, the process may return to block 606 to process additional similar subscribers. If the conversion was a success in block 612, the conversion may be marked as a success in block 614.

The communication may be an advertisement for a product or service, or some other notification where a call to action or other desired action may be present for the subscriber to perform. The conversion tracking may be any of various mechanisms by which a subscriber's actions may be correlated back to the initial communication in block 608. For example, a conversion tracking system may be an advertisement with a customized Uniform Resource Locator (URL) that may register an interaction with an analytics system.

For each seed user in block 616, a conversion rate may be determined for the seed user. Such a conversion rate may be determined by identifying the similar users who were selected based on the seed user's characteristics, and determining a conversion rate. In many cases, such a rate may be expressed in a percentage basis.

If the seed user's conversion rate is not high in block 618, the seed user may be removed from the seed user list in block 620. If the seed user's conversion rate is high in block 620, converting subscribers may be identified in block 624 and added to the seed user list in block 626.

The determination of whether a seed user's conversion rate is high or low in block 620 may be based on historical or expected conversion rates. In many cases, a conversion rate threshold may change as a campaign progresses.

If the campaign is not set to continue in block 628, the campaign may end in block 630. If the campaign is set to continue in block 628, the updated seed user list may be re-processed to generate an updated list of similar subscribers, and another step of the campaign may be executed.

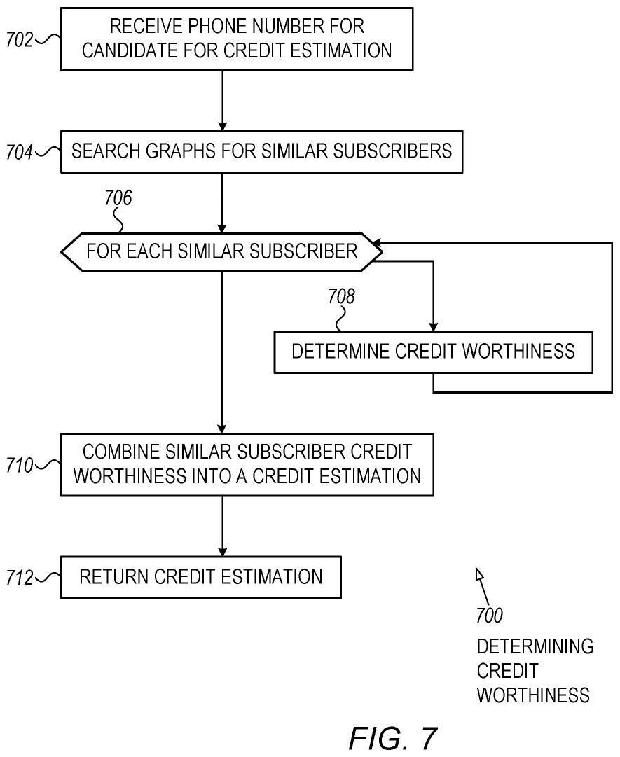

FIG. 7 is a flowchart illustration of an embodiment 700 showing a method of determining creditworthiness. Embodiment 700 is a simplified example of a sequence where telecommunications data may provide insights for determining whether a subscriber may be creditworthy.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 700 may operate on a different principle than embodiments 500 and 600. In the campaign of embodiments 500 and 600, a set of seed users generated a set of similar users who may be exposed to advertisements. In such an iterative process, the list of seed users may be refined as the conversions are measured. In embodiment 700, a set of similar subscribers may be found for a single subscriber, then the creditworthiness of the set may be aggregated to estimate the creditworthiness of the individual subscriber.

The creditworthiness of a subscriber may use credit-related information available to a telecommunications provider. For example, the payment history of similar subscribers, default rate, or other information may be available. In some cases, a telecommunications provider may have credit bureau ratings for some of its subscribers, which may be a third party source of data.

A phone number may be received in block 702 for credit estimation. The subscriber may be analyzed to identify characteristics that may be present in the various graphs, then the graphs may be analyzed to identify similar subscribers in block 704.

For each similar subscriber in block 706, the creditworthiness of the similar subscriber may be determined in block 708. After processing all similar subscribers in block 706, the creditworthiness of the subscriber may be estimated based on the creditworthiness of the similar subscribers in block 710. The credit estimation may be returned in block 712.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principals of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
at least one computer processor;
a set of logs of accesses for a plurality of cellular towers, said logs comprising records, said records comprising a cell tower identifier, a subscriber identifier, and a timestamp;
a set of graphs identifying relationships within said set of logs;
said at least one computer processor configured to perform a method comprising:
receive a first set of telephone numbers, said first set of telephone numbers being associated with a first set of subscribers to said telecommunications network;
for each of said first set of telephone numbers: identifying a set of characteristic relationships, searching for said set of characteristic relationships within said set of graphs, and identifying a lookalike subscriber having a similar set of said characteristic relationships; and
creating a second set of subscribers to said telecommunications network, said second set of subscribers being said lookalike subscribers having said similar set of said characteristic relationships.

2. The system of claim 1, said set of graphs comprising geographical relationships derived from said logs of cellular tower accesses.

3. The system of claim 2, said set of graphs comprising time factors for said geographical relationships.

4. The system of claim 3 further comprising:
interacting with each of said second set of subscribers and determining a set of positive interacting subscribers, said positive interacting subscribers having a confirmed conversion.

5. The system of claim 4, said interacting comprising sending an advertisement.

6. The system of claim 5 further comprising:
for each of said set of positive interacting subscribers, identifying a second set of characteristic relationships, searching for said second set of characteristic relationships within said set of graphs, and identifying at least one positive interacting lookalike subscribers; and
adding said at least one positive interacting lookalike subscribers to said second set of subscribers.

7. The system of claim 6 further comprising:
determining a set of negative interacting subscribers, said negative interacting subscribers not having said confirmed conversion;
for each of said negative interacting subscribers, identifying a third set of characteristic relationships, and comparing said third set of characteristic relationships with said second set of characteristic relationships to identify a set of difference characteristics, said difference characteristics being found in said second set of characteristic relationships and not in said third set of characteristic relationships;
identifying at least one difference subscriber having said difference characteristics, and adding said at least one difference subscriber to said second set of subscribers.

8. A system comprising:
at least one computer processor;
a first set of logs comprising call detail records comprising a first subscriber identifier, a second device, and a timestamp;
a second set of logs of accesses for a plurality of cellular towers, said logs comprising records, said records comprising a cell tower identifier, a subscriber identifier, and a timestamp;
a set of graphs identifying relationships within said first set of logs and said second set of logs;
said at least one computer processor configured to perform a method comprising:
receive a first set of telephone numbers, said first set of telephone numbers being associated with a first set of subscribers to said telecommunications network;
for each of said first set of telephone numbers: identifying a set of characteristic relationships, searching for said set of characteristic relationships within said set of graphs, and identifying a lookalike subscriber having a similar set of said characteristic relationships; and
creating a second set of subscribers to said telecommunications network, said second set of subscribers being said lookalike subscribers having said similar set of said characteristic relationships.

9. The system of claim 8, said set of graphs comprising social relationships derived from said call detail records.

10. The system of claim 9, said call detail records defining phone calls between a first subscriber and said second device.

11. The system of claim 9, said call detail records defining text messages between a first subscriber and said second device.

12. The system of claim 9, said set of graphs comprising time factors for said social relationships.

13. The system of claim 12 further comprising:
interacting with each of said second set of subscribers and determining a set of positive interacting subscribers, said positive interacting subscribers having a confirmed conversion.

14. The system of claim 13, said interacting comprising sending an advertisement.

15. The system of claim 14 further comprising:
for each of said set of positive interacting subscribers, identifying a second set of characteristic relationships, searching for said second set of characteristic relationships within said set of graphs, and identifying at least one positive interacting lookalike subscribers; and
adding said at least one positive interacting lookalike subscribers to said second set of subscribers.

16. The system of claim 15 further comprising:
determining a set of negative interacting subscribers, said negative interacting subscribers not having said confirmed conversion;
for each of said negative interacting subscribers, identifying a third set of characteristic relationships, and comparing said third set of characteristic relationships with said second set of characteristic relationships to identify a set of difference characteristics, said difference characteristics being found in said second set of characteristic relationships and not in said third set of characteristic relationships;
identifying at least one difference subscriber having said difference characteristics, and adding said at least one difference subscriber to said second set of subscribers.

17. A system comprising:
at least one computer processor;
a set of logs comprising call detail records comprising a first subscriber identifier, a second device, and a timestamp;
a set of graphs identifying relationships within said set of logs;
said at least one computer processor configured to perform a method comprising:
receive a first set of telephone numbers, said first set of telephone numbers being associated with a first set of subscribers to said telecommunications network;
for each of said first set of telephone numbers: identifying a set of characteristic relationships, searching for said set of characteristic relationships within said set of graphs, and identifying a lookalike subscriber having a similar set of said characteristic relationships; and
creating a second set of subscribers to said telecommunications network, said second set of subscribers being said lookalike subscribers having said similar set of said characteristic relationships.

18. The system of claim 17, said set of graphs comprising social relationships derived from said call detail records.

19. The system of claim 18, said call detail records defining phone calls between a first subscriber and said second device.

20. The system of claim 18, said call detail records defining text messages between a first subscriber and said second device.

21. The system of claim 18, said set of graphs comprising geographical relationships derived from said logs of cellular tower accesses.

22. The system of claim 21, said set of graphs comprising time factors for said social relationships and time factors for said call detail records.

23. The system of claim 22 further comprising:
interacting with each of said second set of subscribers and determining a set of positive interacting subscribers, said positive interacting subscribers having a confirmed conversion.

24. The system of claim 23, said interacting comprising sending an advertisement.

25. The system of claim 24 further comprising:
for each of said set of positive interacting subscribers, identifying a second set of characteristic relationships, searching for said second set of characteristic relationships within said set of graphs, and identifying at least one positive interacting lookalike subscribers; and
adding said at least one positive interacting lookalike subscribers to said second set of subscribers.

26. The system of claim 25 further comprising:
determining a set of negative interacting subscribers, said negative interacting subscribers not having said confirmed conversion;
for each of said negative interacting subscribers, identifying a third set of characteristic relationships, and comparing said third set of characteristic relationships with said second set of characteristic relationships to identify a set of difference characteristics, said difference characteristics being found in said second set of characteristic relationships and not in said third set of characteristic relationships;
identifying at least one difference subscriber having said difference characteristics, and adding said at least one difference subscriber to said second set of subscribers.

27. The system of claim 21, said set of graphs further comprising a financial interaction graph, said financial interaction graph comprising financial transactions between subscribers and a telecommunications provider.
